(19) United States
(12) Patent Application Publication
(10) Pub. No.: US 2004/0136674 A1
(43) Pub. Date: Jul. 15, 2004

(54) Planar optical waveguide and fabrication process

(76) Inventors: Liubo Hong, San Jose, CA (US); John Edward Gunther, Morgan Hill, CA (US); Peter M.R. Kay, Mountain View, CA (US); Vishal Agarwal, Santa Clara, CA (US); Lin Sun, Cupertino, CA (US)

Correspondence Address: John E. Gunther, Digilens Inc, 615 Palomar Avenue, Sunnyvale, CA, 94086, US

(21) Appl. No.: 10/342,691

(22) Filed: Jan. 15, 2003

(51) Int. Cl. G02B 6/10

(52) U.S. Cl. 385/132

(57) ABSTRACT

An optical waveguide device, ideally suited for use in conjunction with an overlying grating or electro-optic material, is comprised of a substrate, a waveguide core, and an over-cladding layer. The over-cladding layer has an optically flat outer surface. The thickness of the cladding layer over the waveguide core may range from zero to several microns, with thickness uniformity and repeatability within a few percent of the nominal thickness. The thickness control and flatness can be maintained over a large area, such that the waveguide devices can be mass produced on wafers. A process is provided for fabricating the optical waveguide device with a thin, flat, precisely-controlled upper cladding layer. This process comprises the steps of forming an optical waveguide core on a suitable substrate, depositing a thick layer of reflowable cladding material, reflowing the cladding material to provide a planar surface, isotropically etching the cladding material until the top of the waveguide core is exposed, and depositing an additional, thin, precisely-controlled layer of over-cladding material.

### BACKGROUND OF THE INVENTION

This invention relates to optical components for use in fiber optic communications systems. Specifically, the invention relates to a planar optical waveguide, and a fabrication process therefore, suited for use in a variety of optical signal control and switching components that rely upon coupling between a single mode waveguide and an overlying material.

Fiber optic telecommunications systems incorporate a variety of components to control and switch optical signals. One technique used to make such components is to combine an optical waveguide with an overlying material or structure positioned close to the core of the waveguide within the evanescent portion of the waveguide mode field. For example, U.S. Pat. Nos. 4,986,623 and 4,986,624 describe optical filters constructed by placing a periodic grating structure adjacent to the core of a waveguide. Another method of making a filter device is described in “Wavelength tunability of components based on the evanescent coupling from a side-polished fiber to a high-index-overlay waveguide,” Optics Letters, Jun. 15, 1993, pages 1025-27. Additional devices are described in “In-line fibre-optic intensity modulator using electro-optic polymer,” Electronics Letters, 21 May 1992, pages 985-6, and “Single-mode-fiber evanescent polarizer/amplitude modulator using liquid crystals,” Optics Letters, March 1986, pages 180-2.

All of the components referenced above require very precise control of the distance between the core of the optical waveguide and the overlying material. For this reason, the waveguide described in all of the referenced publications is a standard half-coupler. A half coupler, also called a side-polished fiber, is made by bending a fiber around a cylindrical support and then polishing a flat area on the side of the fiber until the core of the waveguide is just below or tangential to the polished surface. The depth of the polish can be controlled precisely by monitoring the insertion loss of the fiber and stopping the polishing process when the insertion loss rises by a predetermined amount.

While the half coupler is a suitable vehicle for experimentation, it is not amenable to mass production since each half-coupler component must be produced individually while monitoring the device performance. Additionally, the technique used to make half-couplers is suitable for use with, at most, two waveguide cores. Finally, the active region of the half coupler is limited to a very short length, typically less than 1 millimetre. Thus the half-coupler platform is not suited for integration of multiple channels or multiple functions into a single device. Thus there exists a need for a mass-producible waveguide device which can offer consistent and uniform coupling from multiple waveguide channels to an overlying material, and which is suited for integration of multiple optical functions into a single component.

### SUMMARY OF THE INVENTION

The present invention provides an optical waveguide device which is ideally suited for use in conjunction with an overlying grating or electro-optic material. Specifically, the waveguide has an optically flat upper surface which may be separated from the waveguide core by a cladding layer of precisely controlled thickness. For the purposes of this application, “optically flat” is defined as flat within a small fraction of the wavelength of light that will be propagated through the waveguide device. The nominal thickness of the cladding layer may range from zero to several microns, with thickness uniformity and repeatability within a few percent of the nominal thickness. The thickness control and flatness can be maintained over a large area, such that the waveguide devices can be mass produced on wafers.

The present invention also provides a process for fabricating an optical waveguide device with a thin, flat, precisely-controlled upper cladding layer. This process comprises the steps of forming an optical waveguide core on a suitable substrate, depositing a thick layer of reflowable upper cladding material, reflowing the upper cladding material to provide a planar surface, isotropically etching the upper cladding material until a small portion of the waveguide core is removed, and depositing an additional, thin, precisely controlled, layer of upper cladding material.

### BRIEF DESCRIPTION OF THE DRAWINGS

FIG. 1A is a schematic perspective view of a prior art device. FIG. 1B and FIG. 1C are two cross-sectional views of the same prior art device.

FIG. 2 is a schematic perspective view of a first embodiment of the invention.

FIG. 3 is a schematic perspective view of a variation of the first embodiment of the invention.

FIGS. 4A to 4G provide a schematic illustration of a process for fabricating the invention.

FIGS. 5A and 5B are schematic cross-sectional views illustrating the benefit of a second embodiment of the invention.

FIG. 6 s a schematic perspective view of a second embodiment of the invention.

FIGS. 7A, 7B, and 7C are schematic cross-section views of addition embodiments of the invention.

FIG. 8 is a schematic perspective view of another embodiment of the invention.

FIG. 9 is a schematic perspective view of yet another embodiment of the invention.

### DETAILED DESCRIPTION OF THE INVENTION

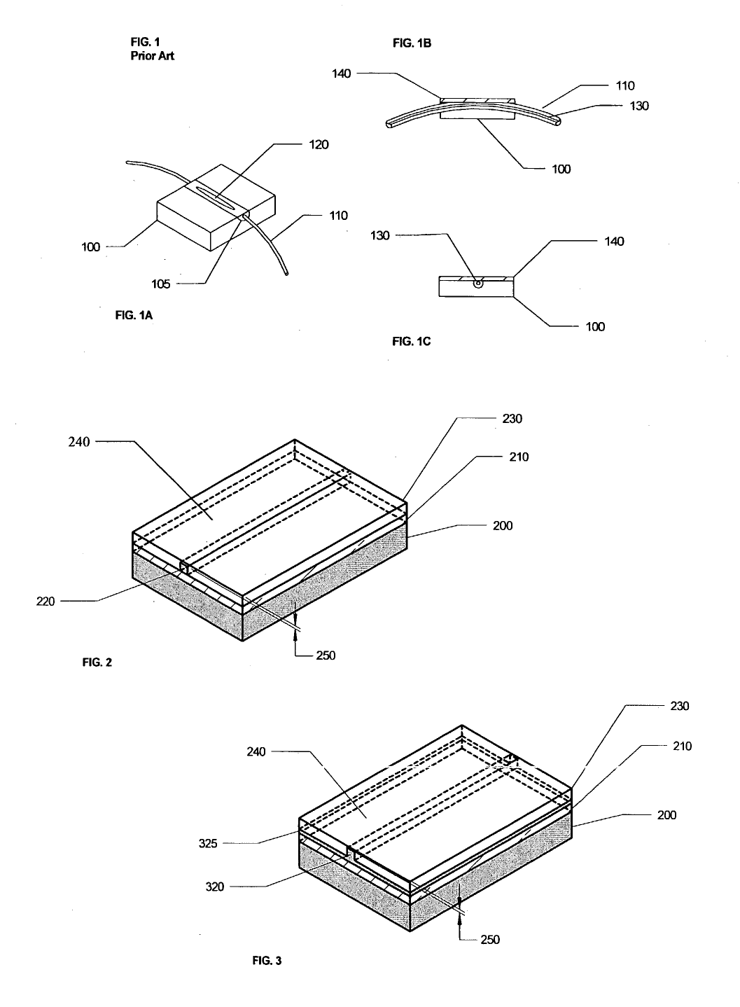

The basic principles and benefits of the invention can be understood by first considering the prior art device shown in FIG. 1A. The prior art device, commonly called either a side-polished fiber or a half-coupler, is comprised of a substrate 100 having a groove containing an optical fiber 110. The side of the optical fiber is polished such that the core of the fiber is exposed over a limited area. Details of the construction of the prior art device can be seen in the cross-sectional views of FIG. 1B and FIG. 1C. Note that the diameter of the optical fiber 110 and the core of the fiber 130 have been greatly exaggerated for clarity. The depth of the groove in substrate 100 follows a long-radius cylindrical curve, such that the side of the fiber 110 extends above the surface of the substrate prior to polishing. The polish depth is controlled such that a portion of the core of the fiber 130 is exposed. One means for controlling the polish depth is to monitor the optical insertion loss through the fiber and stop the polishing process when the loss exceeds a previously determined amount. Typically, an optical element 140 is attached to the polished surface such that the element 140 interacts with the evanescent field of the light travelling in the fiber. As previously referenced, the optical element 140 may be a grating, a slab of material with a high refractive index, an electro-optic material or a thermo-optic material.

The present invention, as shown in FIG. 2, is a planar optical waveguide device comprised of a substrate 200, an undercladding layer 210, a waveguide core 220, and an overcladding layer 230. Note that the dimensions of the core and cladding layers are exaggerated for clarity in FIG. 2 and all subsequent figures. The substrate 200 will commonly be a silicon wafer, but may be another semiconductor material, and the undercladding layer 210 will commonly be a thermally grown or deposited oxide. Alternatively, the substrate 200 may be an optically transparent material such as optical glass or fused silica, in which case the substrate may also function as the undercladding for the waveguide. The core 220 is a suitable optically transparent material having a higher refractive index than that of the undercladding 210. The core is commonly formed by first depositing a continuous film of the selected material by means of chemical vapour deposition, flame hydrolysis deposition, or sputtering. The core structure is form by etching the film layer through a photomask. The overcladding layer 230 is an optically transparent material having a refractive index less than that of the core material. The overcladding commonly, but not necessarily, has the same refractive index as the undercladding layer 210. The indices of the overcladding and undercladding are chosen to generate a confined mode with suitable evanescent characteristics. In the present invention, the overcladding material is a reflowable glass or other material which has self-levelling properties.

The general structure of the present invention is, of course, common to prior art planar optical circuits that also have substrate, undercladding, core, and overcladding layers. The distinguishing features of the present invention are, first, that the upper surface 240 of the overcladding layer is optically flat, and, second, that the thickness of the overcladding layer over the waveguide, as shown by dimension 250, can be very thin and precisely controlled over a large device area. Specifically, the thickness 250 of the overcladding layer over the top of the core can range from zero to several microns in thickness. The thickness of the overcladding layer 250 will be small compared to the thickness of the core 220 and commonly less than the wavelength of the light propagated in the core. The uniformity of the overcladding thickness 250 above the core can be held to a few percent of the selected thickness value over a 100 mm diameter or larger wafer.

The dimensions of the waveguide core and the values of the refractive index of the core and cladding materials are not critical to the present invention. FIG. 3 illustrates an alternative design for the waveguide core comprising a rib 320 extending above a slab layer 325. The rib 320 and slab 325 are normally fabricated from the same material, said material having a refractive index higher than that of the undercladding 210 and overcladding 230 layers.

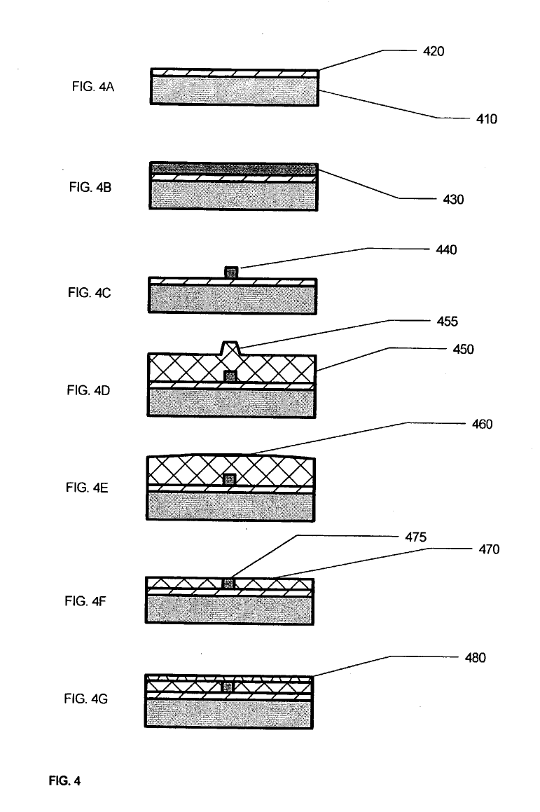

The process for fabrication of the invention is illustrated in FIG. 4, which shows schematic cross-sectional views during successive stages of the fabrication process. Note that the dimensions of the core and cladding layers have been greatly exaggerated, compared to the thickness of the substrate, for clarity. Also note that, while only a single waveguide core is illustrated, the same process can be applied to devices with multiple cores, and to multiple devices fabricated simultaneously on large wafers.

As illustrated in FIG. 4A, the starting point for the process is a substrate 410 having an undercladding layer 420 formed on at least one planar surface. Most commonly, the substrate 410 will be a silicon wafer and the undercladding 420 will be a layer of thermally grown silicon dioxide. Alternatively, the substrate may be silicon or other semiconductor material, and the undercladding may be a deposited dielectric film. To minimize the accumulation of stress in the various films, it is common to deposit or grow the undercladding layer on both sides of a semiconductor substrate. Additionally, the substrate 410 may be an optically transparent material such as fused silica, in which case the undercladding layer 420 may not be required.

The waveguide core is then fabricated in the conventional manner. First, as illustrated in FIG. 4B, a layer of the core material 430 is deposited on top of the undercladding layer. The core layer may be any optically transparent material, selected to have a higher refractive index than that of the undercladding layer. The desired difference in refractive index between the undercladding and core layers may range from 0.3 percent to several percent, depending on the size of the waveguide core, the wavelength of light at which the waveguide will be used, and the intended purpose of the device. The core layer 430 may be deposited by chemical vapour deposition, flame hydrolysis deposition, sputtering, or other well-known deposition techniques. Next, the core 440 is defined by etching through a suitable photo mask. Most commonly, reactive ion etching is used to define smooth, nearly-vertical, side walls, but any suitable etching method may be used. The depth of the etch may be such that the entire core film is removed, leaving a core structure 440 as illustrated in FIG. 4C. Alternatively, the etch process may remove only the upper portion of the core layer, leaving the core structure 320 previously illustrated in FIG. 3.

The next step in the process, as depicted in FIG. 4D, is to deposit a suitable overcladding material. The preferred overcladding material is a reflowable glass, such as Borophosphosilicate Glass (BPSG). BPSG is well known as an interlayer dielectric in semiconductor devices. The overcladding 450 must be deposited with a thickness sufficient to completely bury the waveguide core. It may be advantageous to have the thickness of the overcladding several times the height of the core. After deposition, the profile of the upper surface of the overcladding will be close to a conformal replica of the underlying structures, including a ridge of overcladding material 455 above the waveguide core. The part is then heated in a furnace to a temperature at or above the glass transition temperature of the overcladding material, such that the surface tension causes the material to reflow to form a nearly planar surface 460, as shown in FIG. 4E.

Alternatively, the overcladding material may be a self-leveling polymer material, such as polyimide materials used as inter-layer dielectrics in integrated circuits. Typically, a film of material is applied by spin coating and the surface tension of the material in the liquid state forms a planar surface that is substantially preserved as the film is dried and cured.

As shown in FIG. 4F, the next step in the process is to isotropically etch the overcladding material until the top of the waveguide core 475 is exposed on the etched surface 470. The final step of the fabrication process, as shown in FIG. 4G, is to deposit a thin second overcladding layer, 480. The second overcladding layer may or may not be the same material as the first overcladding material. Since the second overcladding layer 480 is deposited directly on the exposed top of the waveguide core, the thickness of the overcladding on top of the core can be precisely controlled and extremely thin if desired.

Of course, a simpler alternative process sequence would be to etch the planarized overcladding layer and stop etching when the overcladding thickness above the core reached the desired final value. This alternative process sequence, however, cannot provide consistent overcladding thickness due to the tolerances of the overcladding deposition and the etching processes. For example, assume that the overcladding layer is nominally 20 microns thick prior to etching, and the desired final thickness is 0.4 microns on top of a core height of 5.0 microns. With current equipment, the overcladding deposition and etching processes may both have rate variations of ±1% over the surface of a wafer. The tolerances of the two processes will add such that the worst-case variation of the over cladding thickness above the core will be ±1% of the total of the deposition thickness and the etch depth, or ±0.35 microns. This is equivalent to ±87.5% of the desired 0.4 micron thickness. This larger variation in overcladding thickness above the core would result in wide performance variations and unacceptably low production yield.

Using the process of the present invention, the waveguide core is initially formed somewhat thicker than the desired final value, such that some of the core is removed during the isotropic etching process. In the example case, assume that the core was initially formed 5.5 microns thick, and the etching step is continued until nominally 0.5 microns is removed from the core height. In this case, the ±0.35 microns cumulative tolerance on the overcladding deposition and etch processes is applied to the final height of the waveguide core. In the example, the final core height will be 5.0±0.35u microns, or 5.0±7%, microns which will have only a small effect on the performance of the waveguide device. The final thickness of the cladding over the core is determined by the second overcladding deposition process. For this process to be successful, the excess height added to the core during deposition must be more than the anticipated worst-case cumulative error in the overcladding deposition and etching processes.

The planarity of the finished device will be essentially the same as the planarity of the upper surface of the overcladding before the isotropic etch. As previously shown in FIG. 4D, at the completion of the overcladding deposition process, each device has a rib of overcladding material 455 above the waveguide core. During the subsequent planarization process, the surface tension of the overcladding material must pull the surface flat such that the rib of material 455 flows down into the device surface, as shown in FIG. 4E. Assuming that the overcladding material is BPSG, the planarity of the surface after the reflow planarization process step will depend on a number of parameters, including the exact BPSG material composition, the reflow process, and the distance that the excess material must flow during the process.

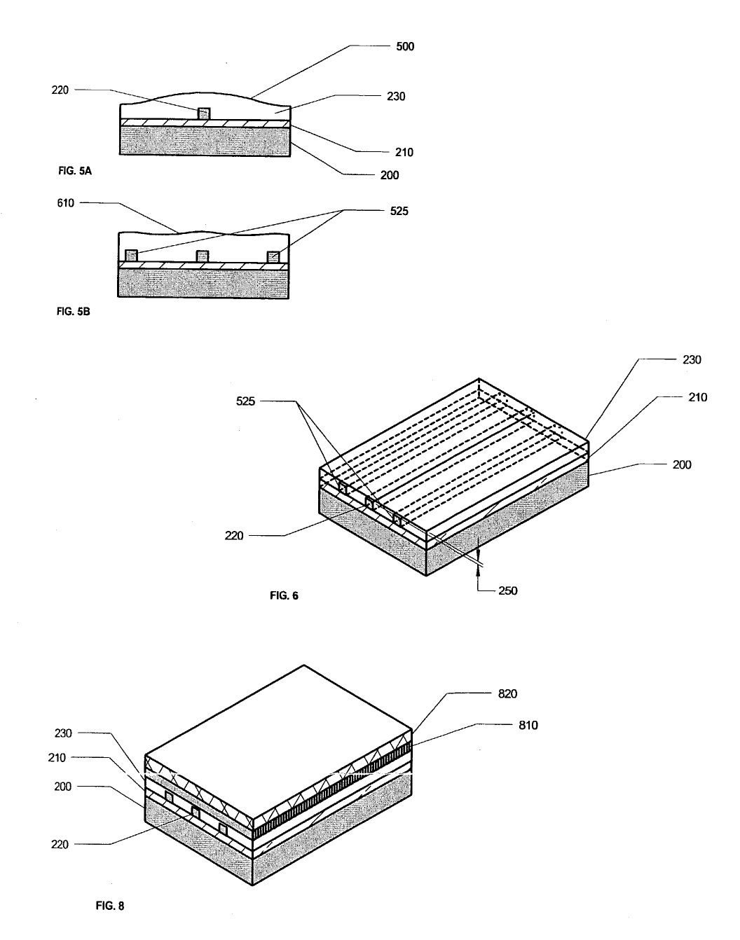

We have found that the reflow process produces a more planar surface over multiple repeated structures than over a single isolated structure. This effect can be understood through comparison of FIG. 5A and FIG. 5B. FIG. 5A shows an end view of the substrate 200, undercladding 210, a single waveguide core 220, and reflowed overcladding 230. In the device shown in FIG. 5B and FIG. 6, additional elements 525, similar in cross-section to the waveguide core, have been positioned parallel to the waveguide core to facilitate the reflow process. Note that these elements do not serve any optical function in the planar optical device, but simply serve to shorten the distance that material must be displaced during the reflow process. These elements must be positioned close enough to the core to facilitate the reflow process, but sufficiently distant from the core to ensure that light does not couple from the core to adjacent elements.

The invention can be further understood by means of the following example. Starting with a 100 mm silicon wafer having 10 microns of thermal oxide on both surfaces, a core layer is deposited by PECVD and the core structures are etched using reactive ion etching through a Chrome hard mask. The core structures are generally as previously illustrated in FIG. 3. Each waveguide core is a rib 4.5 microns wide with an initial height of 4.0 microns on top of a slab of high index material having a thickness of 1.0 microns. Additional elements having the same cross-section as the cores are formed during the etching process. These elements are placed parallel to both sides of the cores, and are spaced on 50 micron centers. The BPSG overcladding is then deposited by PECVD to a target thickness of 20 microns and immediately reflowed at 1200 degrees C. After reflow, the BPSG thickness is measured at several points on the wafer. The wafer surface is then isotropically etched using reactive ion etching. The nominal etch depth is selected to reduce the waveguide core rib height to the desired final value of 3.5 microns. A second BPSG overcladding layer is then deposited to a desired final thickness between 0.2 and 0.6 microns. The surface of the completed device is virtually planar with peak-valley deviations of less than 300 angstroms. The thickness of the overcladding layer on top of the waveguide core is equal to the target value within 2% over the entire 4″ diameter wafer.

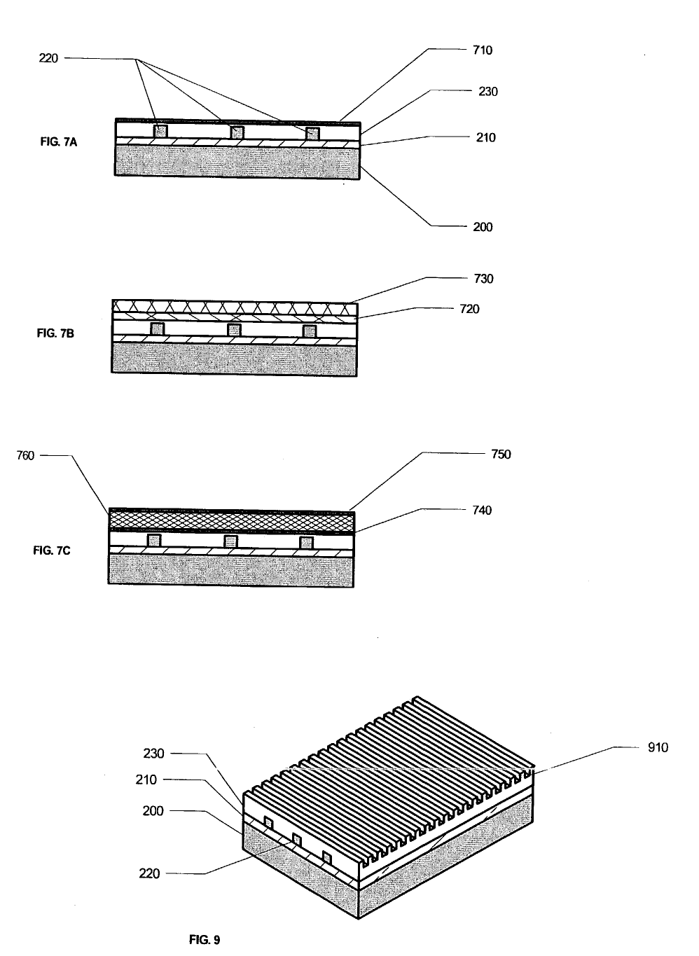

Intended applications of the present invention are illustrated schematically in FIG. 7 through FIG. 9. FIG. 7A illustrates a waveguide polarizer device comprising a substrate 200, undercladding 210, waveguide cores 220, and over cladding 230 of the present invention with the additional of a metal film 710 on the surface of the device. The metal film will attenuate the TM mode propagating in the waveguide core. This device may be useful as a component of a multifunction planar lightwave circuit.

FIG. 7B illustrates the use of the invention in conjunction with a high index overlay 720 and a superstrate 730, as described by Moody and Johnston in “Wavelength tenability of components based on the evanescent coupling from a side-polished fiber to a high index overlay waveguide,” Optics Letters Vol. 18, No. 12, pages 1025-1027, Jun. 15, 1993. This device may be useful as an optical band pass or band reject filter.

FIG. 7C illustrates the use of the invention in conjunction with an electro-optic material 760 sandwiched by transparent electrodes 740, 750. This device may be useful as an optical attenuator or intensity modulator, as described by Fawcett et. al. in “In-line fibre-optic intensity modulator using electro-optic polymer,” Electronics Letters Vol. 28, No. 11, page 985-986, May 21, 1992.

FIG. 8 illustrates the use of the invention in conjunction with an Electrically Switchable Bragg Grating (ESBG) 810 sandwiched between the surface of the waveguide device and a cover plate 820. Domash discloses a range of ESBG devices in U.S. Pat. No. 5,937,115. The cover plate 820, the surface of the waveguide overcladding, or both must have electrodes for applying an electric field across the ESBG layer in order to change the index modulation and diffraction efficiency of the Bragg grating. Changing the index modulation of the grating will result in wavelength-selective coupling of light from the waveguide core to forward or backward propagating modes in either the ESBG layer or adjacent waveguide cores. This latter property provides the basis for a wide range of OADM architectures.

FIG. 9 illustrates the invention with the addition of a grating 910 formed on the surface of the overcladding 230. The grating may be etched into the surface of the overcladding, or may be etched into an additional film layer deposited on the overcladding. This device may be useful as an optical filter.

While the invention has been shown and described above with respect to selected structures, processes and applications, it should be understood that these structures, processes and applications are by way of example only and that one skilled in the art could construct other structures and applications utilizing techniques other than those specifically disclosed and still remain within the scope of the invention.

What is claimed is:

1. A planar optical waveguide device, comprising:
an undercladding supported by a substrate, said undercladding having a planar surface, at least one waveguide core having a bottom surface disposed on said undercladding, a top surface parallel to said bottom surface, and opposed first and second sides, and
an overcladding surrounding the top and sides of said waveguide core, said overcladding having a planar outer surface disposed proximate to and parallel to the top surface of the waveguide core,
wherein said outer surface of said overcladding is optically flat and the thickness of said overcladding, from said top surface of the waveguide core to said outer surface of the overcladding, is small compared to the distance between said top and bottom surfaces of said waveguide core.

2. The planar optical waveguide device of claim 1, wherein said optical flatness and thickness of said overcladding layer are maintained over a large area substrate comprising multiple optical waveguide devices.

3. The planar optical waveguide device of claim 1, wherein said undercladding is comprised of an optically transparent material such as optical glass or fused silica which also serves as a supporting substrate.

4. The planar optical waveguide device of claim 1, wherein said undercladding is comprised of an optically transparent layer disposed on a surface of a semiconductor wafer that serves as a supporting substrate.

5. The planar optical waveguide device of claim 1, wherein said overcladding is further comprised of:
a first overcladding that surrounds the two sides of the waveguide core, said first overcladding having a top surface that is coplanar with the top surface of said waveguide core, and
a second overcladding disposed as a thin film on the coplanar top surfaces of said first overcladding and said waveguide core.

6. The planar optical waveguide device of claim 5, wherein said first overcladding is comprised of a reflowable glass material.

7. The planar optical waveguide device of claim 5, wherein said first overcladding is comprised of a self-levelling material.

8. The planar optical waveguide device of claim 1, wherein the thickness of said overcladding, from said top surface of the core to said outer surface of the overcladding, is less than the wavelength of the light that will be guided in the waveguide.

9. The planar optical waveguide device of claim 8, wherein the thickness of said overcladding, from said top surface of the core structure to said outer surface of the overcladding, is less than 600 nanometres.

10. The planar optical waveguide device of claim 1, further comprising:
at least one optically inactive element disposed on said planar surface of the undercladding roughly parallel to the first side of the waveguide core, and
at least one optically inactive element disposed on said planar surface of the undercladding roughly parallel to the second side of the waveguide core,
wherein said optically inactive elements have generally the same cross section as said waveguide core, and the spacing between said waveguide core and said first and second elements is sufficient to preclude light from coupling from the waveguide core to said elements

11. A method for fabricating a planar optical waveguide device comprising the steps of:
providing an undercladding supported by a substrate and having a planar surface,
forming at least one waveguide core disposed on said surface of said undercladding, said core having a height normal to the surface of said undercladding,
depositing a first overcladding on top of said undercladding and said waveguide core, said first overcladding having sufficient thickness to completely cover said waveguide core,
processing said first overcladding material to provide a planar surface,
isotropically etching said first overcladding layer until the top of said waveguide core is exposed, and
depositing a thin layer of a second over cladding material.

12. The method of claim 11, wherein:
the first overcladding is comprised of a reflowable glass material, and
said step of processing said first overcladding material to provide a planar outer surface comprises reflowing the reflowable glass material at high temperature in a furnace.

13. The method of claim 12, wherein said reflowable material is Borophosphosilicate Glass (BPSG).

14. The method of claim 11, wherein:
the first overcladding is comprised of a self-levelling spin-coatable organic material, and
said step of processing said first overcladding material to provide a planar outer surface comprises baking the self-levelling material.

15. The method of claim 14, wherein said self-levelling spin-coatable organic material is a polyimide.

16. The method of claim 11, wherein
said process of forming a waveguide core comprises forming a waveguide core having excess height above the height desired for the completed waveguide core, and
said process of isotropically etching is continued until said excess core height is removed.

17. The method of claim 16, wherein:
said processes of depositing a first overcladding and isotropically etching said first overcladding layer have process tolerances, said process tolerances additive to define a worst-case error in the post-etch thickness of the first overcladding, and
said excess core height is greater than said worst-case error.

18. The method of claim 11, wherein
said process of forming a waveguide core also forms at least one optically inactive element disposed on said planar surface of the undercladding roughly parallel to the first side of the waveguide core and at least one optically inactive element disposed on said planar surface of the undercladding roughly parallel to the second side of the waveguide core,
wherein said optically inactive elements have generally the same cross section as said waveguide core and serve to facilitate the subsequent step of processing said first overcladding material to provide a planar surface.

19. The method of claim 11, wherein
said substrate is a large-area substrate comprising multiple optical waveguide devices, and
said method additional comprises excising the completed devices from said large area substrate.
